(19) United States
(12) Patent Application Publication
(10) Pub. No.: US 2026/0025666 A1
(43) Pub. Date: Jan. 22, 2026

(54) SYSTEM AND METHOD FOR PREVENTING MISAPPROPRIATION OF SHORT WIRELESS COMMUNICATION ENABLED DEVICES

(71) Applicant: BANK OF AMERICA CORPORATION, Charlotte, NC (US)

(72) Inventors: Sneha Padiyar, Mumbai (IN); Hariharan Balakrishnan, Chennai (IN); Abhijit Behera, Hyderabad (IN); Nidhi Khaitan, Jagadhri (IN); Sakthi Priya, Chennai (IN); Swetha Sadhu, Hyderabad (IN); Pooja Ranchhodbhai Sojitra, Ahemdabad (IN); Charulatha Ulaganathan, Vellore (IN)

(73) Assignee: BANK OF AMERICA CORPORATION, Charlotte, NC (US)

(21) Appl. No.: 18/774,432

(22) Filed: Jul. 16, 2024

(51) Int. Cl. H04W 12/63; H04W 4/14

(52) U.S. Cl. CPC H04W 12/63; H04W 4/14

(57) ABSTRACT

Embodiments of the present invention provide a system for preventing misappropriation of short wireless communication enabled devices. In particular, the system may be configured to identify initiation of an interaction, via a short wireless communication enabled device, with an interaction device by a user at an entity location, determine that the short wireless communication enabled device is linked with at least one user device, determine if the at least one user device is within a predefined distance of the short wireless communication enabled device and the interaction device, and approve or deny the interaction based on determining that the at least one user device is within the predefined distance of the short wireless communication enabled device.

### BACKGROUND

There exists a need for a system for preventing misappropriation of short wireless communication enabled devices.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for preventing misappropriation of short wireless communication enabled devices. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention identifies initiation of an interaction, via a short wireless communication enabled device, with an interaction device by a user at an entity location, determines that the short wireless communication enabled device is linked with at least one user device, determines if the at least one user device is within a predefined distance of the short wireless communication enabled device and the interaction device, and approves or denies the interaction based on determining that the at least one user device is within the predefined distance of the short wireless communication enabled device.

In some embodiments, the present invention receives a request from the user to link the at least one user device with the short wireless communication enabled device, prompts the user to provide a secret code to link the at least one user device with the short wireless communication enabled device; and verifies the secret code and link the at least one user device with the short wireless communication enabled device.

In some embodiments, the present invention receives one or more interaction limits for the at least one user device, wherein the one or more interaction limits define the interaction capabilities of the at least one user device and creates a dynamic smart contract associated with the at least one user device and the short wireless communication enabled device based on the one or more interaction limits.

In some embodiments, the present invention receives updated interaction limits for the at least one user device and updates the dynamic smart contract with the updated interaction limits.

In some embodiments, the present invention approves or denies the interaction based on the dynamic smart contract.

In some embodiments, the present invention controls an Internet of Things (IoT) sensor on the short wireless communication enabled device to record one or more patterns associated with handling of the short wireless communication enabled device.

In some embodiments, the present invention compares the one or more patterns with baseline data, determines that the one or more patterns do not match the baseline data, and generates and transmits an alert to the user based on determining that the one or more patterns do not match the baseline data.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for preventing misappropriation of short wireless communication enabled devices, in accordance with an embodiment of the invention;

FIG. 2 provides a block diagram illustrating the entity system 200 of FIG. 1, in accordance with an embodiment of the invention;

FIG. 3 provides a block diagram illustrating a misappropriation prevention system 300 of FIG. 1, in accordance with an embodiment of the invention;

FIG. 4 provides a block diagram illustrating the computing device system 400 of FIG. 1, in accordance with an embodiment of the invention;

FIG. 5 provides a process flow for preventing misappropriation of short wireless communication enabled devices, in accordance with an embodiment of the invention; and

FIG. 6 provides a block diagram illustrating one or more components of a short wireless communication enabled device, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, the term “resource entity” or “entity” may be any institution which involves in financial transactions. In one embodiment, the term “entity” or “resource entity” may be any financial institution. As used herein, the term “interaction device” may be any device associated with the entity or a third party entity (e.g., merchant) that allows users to perform one or more interactions associated with resource pools (e.g., credit account, checking account, savings account, money market account, and/or the like) of the users.

In some embodiments of the present invention, the interaction device associated with the entity may be an automated machine. In some embodiments, the “automated machine” may be any automated device that is involved in distribution of resources such as cash, checks, electronic transfers, money orders or the like which may be performed using a credit card, a debit card, or the like. In one embodiment of the present invention, the automated machine may be an Automated Teller Machine (ATM). In some embodiments, the “automated machine” may be any automated device that provides information associated with resource pools of the user. In some embodiments, the automated machine may be owned and/or controlled by the entity.

In some embodiments, an interaction device associated with the third party entity may be a Point of Sale (POS) device. In some embodiments, an interaction device may be an online server, where the online server may be a cloud based server. A “short wireless communication enabled device” as used herein may be any instrument used by the users to perform to initiate interactions or resource distribution requests. Examples of short wireless communication enabled devices may include, but are not limited to, a credit card, a debit card, or the like.

As described herein, a “user” may be a customer or a potential customer of the entity. In some embodiments, a “user” may be a financial institution customer (e.g., an account holder or a person who has an account (e.g., banking account, credit account, or the like)). An “account” or “resource pool” may be the relationship that the customer has with the financial institution. Examples of accounts include a deposit account, such as a transactional account (e.g. a banking account), a savings account, an investment account, a money market account, a time deposit, a demand deposit, a pre-paid account, a credit account, a non-monetary customer information that includes only personal information associated with the customer, or the like. The account is associated with and/or maintained by a financial institution.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

“Smart contract” as used herein may refer to executable computer code or logic that may be executed according to an agreement between parties upon the occurrence of a condition precedent (e.g., a triggering event such as the receipt of a proposed data record). In some embodiments, the smart contract may be self-executing code that is stored in the distributed ledger, where the self-executing code may be executed when the condition precedent is detected by the system on which the smart contract is stored.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Typically, short wireless communication enabled devices used to perform interactions by users do not have any authentication mechanisms in place for verifying if a user who is initiating the interaction is an authorized user or an unauthorized user, thereby making it challenging to prevent misappropriation of short wireless communication enabled devices. As such, there exists a need for a system that prevents misappropriation of short wireless communication enabled devices. The system of the invention solves this problem as described below.

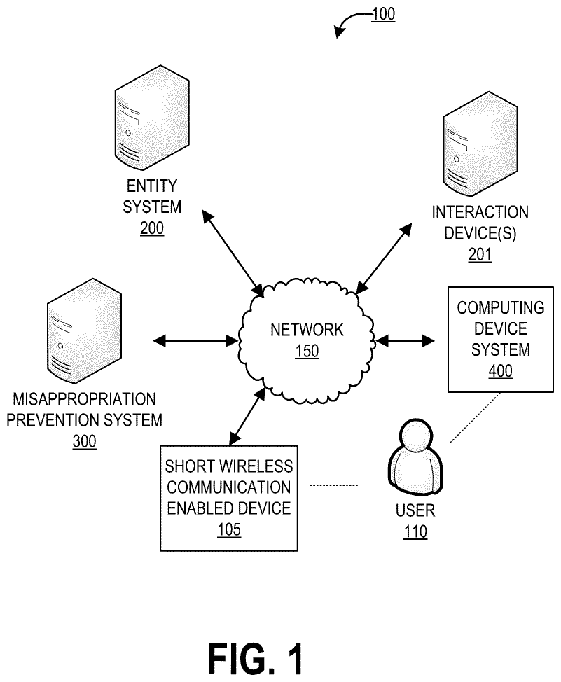

FIG. 1 provides a block diagram illustrating a system environment 100 for preventing misappropriation of short wireless communication enabled devices, in accordance with an embodiment of the invention. As illustrated in FIG. 1, the environment 100 includes a misappropriation prevention system 300, entity system 200, one or more interaction devices 201, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be customers of an entity associated with the entity system 200, where the entity maintains and/or manages one or more resource pools (e.g., checking account, savings account, or the like) associated with the users 110. In some embodiments, one or more short wireless communication enabled devices 105 associated with the one or more users 110 may be a part of the environment 100, where the short wireless communication enabled devices may be devices used by the users to perform interactions or resource distribution requests. Examples of short wireless communication enabled devices may include, but are not limited to, a physical credit card, a physical debit card, or the like.

The entity system(s) 200 may be any system owned or otherwise controlled by an entity to support or perform one or more process steps described herein. In some embodiments, the entity is a financial institution. In some embodiments, the one or more interaction devices 201 may be owned, operated, controlled, and/or maintained by the entity and/or third party entity. Examples of the one or more interaction devices may include, but are not limited to, Automated Teller Machines, Point of Sale devices, online servers, or the like that allows users 110 to perform one or more interactions associated with resource pools of the users 110.

The misappropriation prevention system 300 is a system of the present invention for performing one or more process steps described herein. In some embodiments, the misappropriation prevention system 300 may be an independent system. In some embodiments, the misappropriation prevention system 300 may be a part of the entity system 200.

The misappropriation prevention system 300, the entity system 200, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the misappropriation prevention system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the misappropriation prevention system 300, and/or entity system 200 across the network 150. In some embodiments of the invention, the computing device system 400 may be a mobile device.

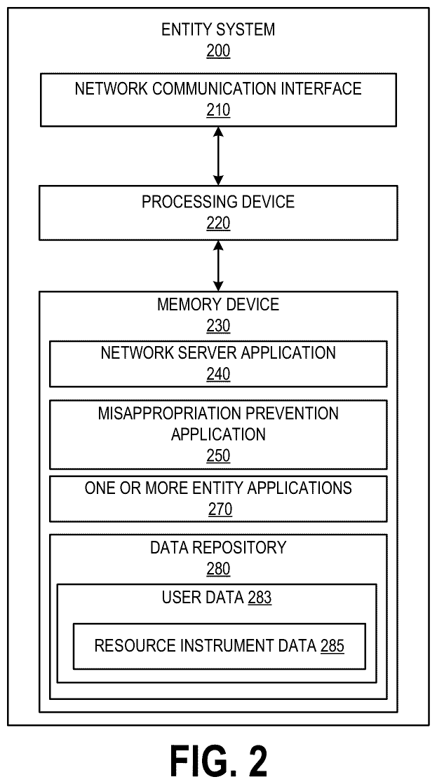

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, an misappropriation prevention application 250, one or more entity applications 270, and a data repository 280 comprising user data 283, where the user data 283 comprises data associated with users 110 and/or one or more resource pools associated with the users 110. The user data 283 further comprise short wireless communication enabled device data 285 associated with the users of the corresponding user data 283. The one or more entity applications 270 may be any applications provided by the entity that allows users 110 to access information and/or perform one or more actions associated with one or more resource pools of the users 110. The computer-executable program code of the network server application 240, the misappropriation prevention application 250, the one or more entity application 270 to perform certain logic, data-extraction, and data-storing functions of the entity system 200 described herein, as well as communication functions of the entity system 200.

The network server application 240, the misappropriation prevention application 250, and the one or more entity applications 270 are configured to store data in the data repository 280 or to use the data stored in the data repository 280 when communicating through the network communication interface 210 with the misappropriation prevention system 300, and/or the computing device system 400 to perform one or more process steps described herein. In some embodiments, the entity system 200 may receive instructions from the misappropriation prevention system 300 via the misappropriation prevention application 250 to perform certain operations. The misappropriation prevention application 250 may be provided by the misappropriation prevention system 300.

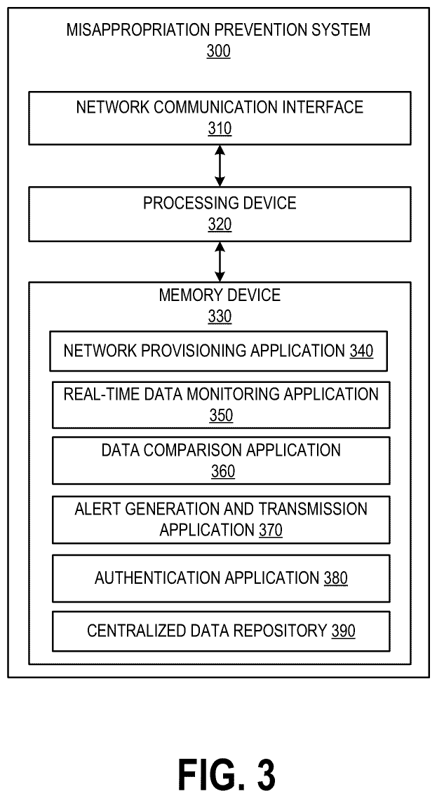

FIG. 3 provides a block diagram illustrating the misappropriation prevention system 300 in greater detail, in accordance with embodiments of the invention. As illustrated in FIG. 3, in one embodiment of the invention, the misappropriation prevention system 300 includes one or more processing devices 320 operatively coupled to a network communication interface 310 and a memory device 330. In certain embodiments, the misappropriation prevention system 300 is operated by a first entity, such as a financial institution, while in other embodiments, the misappropriation prevention system 300 is operated by an entity other than a financial institution. In some embodiments, the misappropriation prevention system 300 is owned or operated by the entity of the entity system 200. In some embodiments, the misappropriation prevention system 300 may be an independent system. In alternate embodiments, the misappropriation prevention system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the misappropriation prevention system 300 described herein. For example, in one embodiment of the misappropriation prevention system 300, the memory device 330 includes, but is not limited to, a network provisioning application 340, a real-time data monitoring application 350, a data comparison application 360, an alert generation and transmission application 370, an authentication application 380, and a centralized data repository 390 comprising data processed or accessed by one or more applications in the memory device 330. The computer-executable program code of the network provisioning application 340, the real-time data monitoring application 350, the data comparison application 360, the alert generation and transmission application 370, and the authentication application 380 may instruct the processing device 320 to perform certain logic, data-processing, and data-storing functions of the misappropriation prevention system 300 described herein, as well as communication functions of the misappropriation prevention system 300.

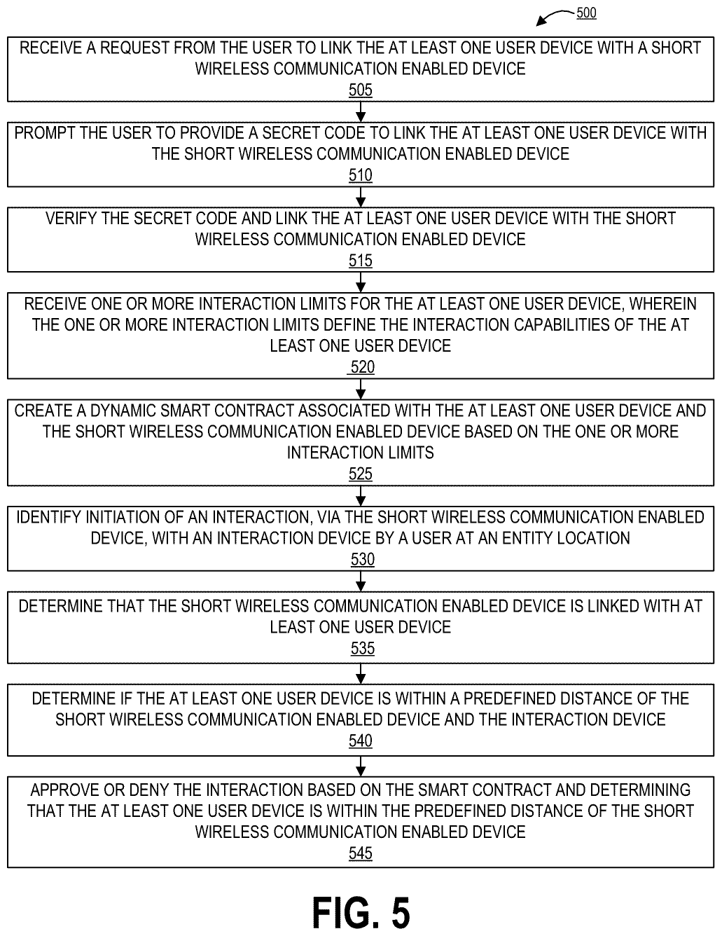

The network provisioning application 340, the real-time data monitoring application 350, the data comparison application 360, the alert generation and transmission application 370, and the authentication application 380 are configured to invoke or use the data in the data repository 390 when communicating through the network communication interface 310 with the entity system 200, and/or the computing device system 400. In some embodiments, the network provisioning application 340, the real-time data monitoring application 350, the data comparison application 360, the alert generation and transmission application 370, and the authentication application 380 may store the data extracted or received from the entity system 200, and the computing device system 400 in the centralized data repository 390. In some embodiments, the network provisioning application 340, the real-time data monitoring application 350, the data comparison application 360, the alert generation and transmission application 370, and the authentication application 380 may be a part of a single application. The functionalities of the network provisioning application 340, the real-time data monitoring application 350, the data comparison application 360, the alert generation and transmission application 370, and the authentication application 380 are explained in greater detail in FIG. 5.

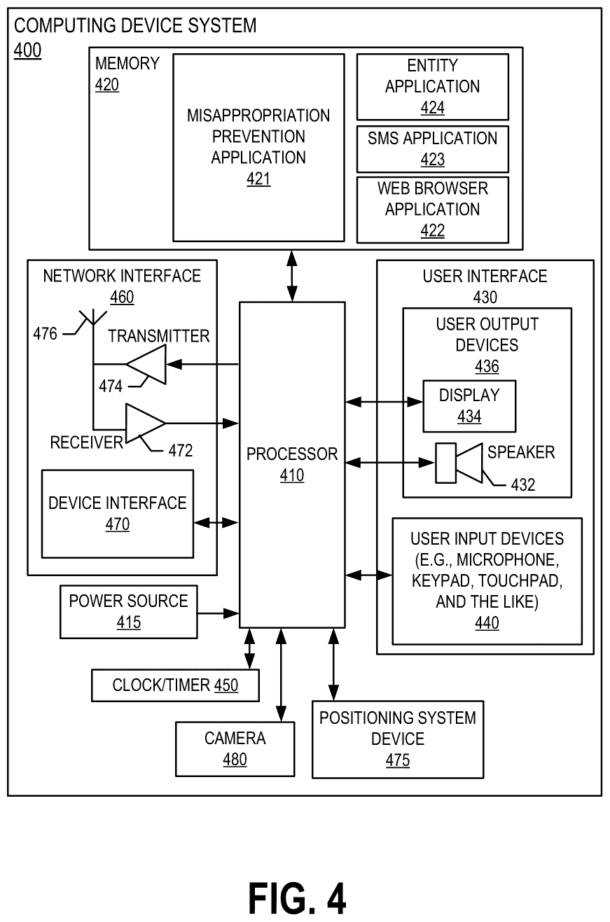

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include desktop computers, laptops, portable digital assistants (PDAs), pagers, mobile televisions, entertainment devices, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a misappropriation prevention application 421, entity application 424, an SMS application 423, or the like. In some embodiments, the entity application 424 may be an online banking application. The misappropriation prevention application 421 may comprise instructions to a graphical user interface (GUI) on the display 430 that allows the user 110 to interact with the entity system 200, the misappropriation prevention system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the misappropriation prevention application 421 provided by the misappropriation prevention system 300 allows the user 110 to access the misappropriation prevention system 300. In some embodiments, the entity application 424 provided by the entity system 200 and the misappropriation prevention application 421 allow the user 110 to access the functionalities provided by the misappropriation prevention system 300 and the entity system 200. In some embodiments, the entity application 424 may be an online banking application.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

FIG. 5 provides a process flow for preventing misappropriation of short wireless communication enabled devices, in accordance with an embodiment of the invention. As shown in block 505, the system receive a request from the user to link the at least one user device with a short wireless communication enabled device. The short wireless communication enabled device may be any Near Field Communication (NFC) enabled resource distribution device (e.g., credit card, debit card, and/or the like). The user device may be any of the computing device systems described herein (e.g., desktop computer, laptop, mobile device, entertainment devices, wearable devices, and/or the like). The system may provide a user interface that allows the user to submit the request to link the at least one user device with the short communication enabled device. The user interface may also allow the user to manage the short wireless communication enabled devices and the one or more user devices linked to the short wireless communication enabled devices. For example, the system may allow the user to delink a mobile phone with a NFC enabled credit card. In some embodiments, the user interface may be a part of an entity application (e.g., online banking application) provided by an entity managing and/or maintaining one or more resource pools (e.g., checking account, savings account, credit account, and/or the like) associated with the user, wherein the short wireless communication enabled devices are associated with the one or more resource pools.

As shown in block 510, the system prompts the user to provide a secret code to link the at least one user device with the short wireless communication enabled device. In some embodiments, the secret code may be any code or password set up the user while signing up for the service described herein that is provided by the system. In some embodiments, the secret code may be an authentication password used by the user to access the entity application.

As shown in block 515, the system verifies the secret code and link the at least one user device with the short wireless communication enabled device. Linking the at least one user device with the short wireless communication enabled device comprises associating the at least one user device with the short wireless communication enabled device which allows the user to perform interactions in a secure manner. The linking mechanism allows the user to perform interactions with the short wireless communication enabled device only when the at least one user device linked with the short wireless communication enabled device is within a predefined distance from the short wireless communication enabled device, thereby adding an extra layer of security without requiring any additional input or action from the user. In some embodiments, the short wireless communication enabled device may comprise a primary user device and a second user device based on inputs received from the user. For example, the user may define a smart watch as the primary device and a mobile phone as the secondary device for an NFC enabled credit card. In some embodiments, the system may automatically assign user devices as primary devices and secondary devices linked with the short wireless communication enabled devices of the user based on the usage of the user devices. For example, the system may determine that the usage of the mobile phone of the user is very high and may assign the mobile phone as the primary device for an NFC enabled debit card. In response to linking the at least one user device to the short wireless communication enabled device, the system may create a record associated with the link in a data repository (e.g., data repository 390).

As shown in block 520, the system receives one or more interaction limits for the at least one user device, wherein the one or more interaction limits define the interaction capabilities of the at least one user device. The one or more interaction limits may comprise interaction amounts, third party entity restrictions, location based restrictions, the predefined distance limit, and/or the like. In some embodiments, the system may suggest the one or more interaction limits based on historical user data, where the suggestions may be based on whether the user device is a primary device, a second device, or the like.

As shown in block 525, the system creates a dynamic smart contract associated with the at least one user device and the short wireless communication enabled device based on the one or more interaction limits. The system may establish the dynamic smart contract based on the one or more interaction limits. The dynamic smart contract may be altered based on dynamic interaction limits provided by the user via the user interface. In some embodiments, the user may provide updated interaction limits for the at least one user device and the system may update the dynamic smart contract with the updated interaction limits

As shown in block 530, the system identifies initiation of an interaction, via the short wireless communication enabled device, with an interaction device (e.g., POS device) by a user at an entity location (e.g., merchant location). In some embodiments, the system may continuously monitor the short wireless communication enabled device and/or the user devices linked with the short wireless communication enabled device to detect initiation of interactions by the user. In some embodiments, the system may receive a notification from the short wireless communication enabled device and/or the user devices linked with the short wireless communication enabled device about the initiation of the interaction.

As shown in block 535, the system determines that the short wireless communication enabled device is linked with at least one user device. The system may extract a list associated with the short wireless communication enabled device from the data repository, where the list comprises the at least one user device linked with the short wireless communication enabled device via the linking mechanism provided by the system.

As shown in block 540, the system determines if the at least one user device is within a predefined distance of the short wireless communication enabled device and the interaction device. In some embodiments, the system may communicate directly with the short wireless communication enabled device to determine the location of the short wireless communication enabled device and may separately communicate with the at least one user device to determine the location of the at least one user device. Based on determining the locations of the short wireless communication enabled device and the at least one user device, the system may calculate the distance between the short wireless communication enabled device and the at least one user device to determine if the at least one user device is within the predefined distance of the short wireless communication enabled device. In some embodiments, the system may establish a communication link with the short wireless communication enabled device and transmit instructions to the short wireless communication enabled device, where the instructions cause the short wireless communication enabled device to detect the presence of the at least one user device within the predefined distance of the short wireless communication enabled device and report the detection of the at least one user device back to the system.

As shown in block 545, the system approves or denies the interaction based on the smart contract and determining that the at least one user device is within the predefined distance of the short wireless communication enabled device. In some embodiments, the system may determine that the at least one user device is within the predefined distance of the short wireless communication enabled device and may then implement the smart contract by checking conditions of the smart contract. If the system determines that the at least one user device is within the predefined distance of the short wireless communication enabled device and the interaction meets the one or more interaction limits in the smart contract, the system approves the interaction. If the system determines that the at least one user device is not within the predefined distance of the short wireless communication enabled device and/or the interaction does not meet the one or more interaction limits in the smart contract, the system denies the interaction.

In some embodiments, the system may control an Internet of Things (IoT) sensor on the short wireless communication enabled device to record one or more patterns associated with handling of the short wireless communication enabled device. For example, the system may record the movement of the user, movements, vibrations etc. associated with handling of the NFC enabled credit card of the user. In response to recording the one or more patterns, the system may compare the one or more patterns with baseline data, determine that the one or more patterns do not match the baseline data, and generate and transmit an alert to the user based on determining that the one or more patterns do not match the baseline data, where the alerts provide a notification to the user that the short wireless communication enabled device may be misappropriated and allows the user to prevent initiation of misappropriations by unauthorized users. The system may determine the baseline data based on tracking actions of the user over a period of time.

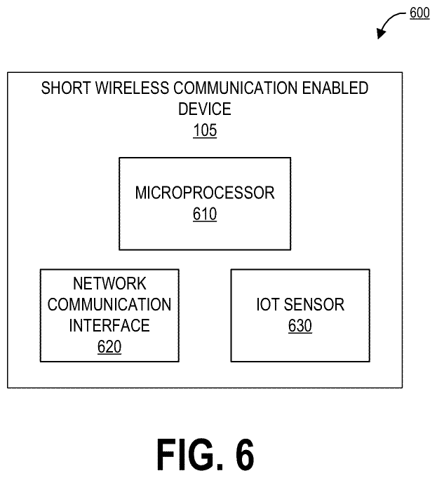

FIG. 6 provides a block diagram illustrating one or more components of a short wireless communication enabled device, in accordance with an embodiment of the invention. As shown, the short wireless communication enabled device 105 comprises a network communication interface 620, a microprocessor 610, and an IoT sensor 630. It should be understood that there may be other components of the short wireless communication enabled device that are not shown in the figure, where the other components may perform one or more operations described herein. The network communication interface 620 may be responsible for transmitting and receiving all network communications associated with the short wireless communication enabled device 105. The microprocessor 610 interacts with other components and provides the processing capability to implement/process one or more actions described herein (e.g., smart contract) and/or execute one or more instructions received from the misappropriation prevention system 300. In some embodiments, the IoT sensor may be any mechanism or tool integrated into the short wireless communication enabled device 105 used for gathering information associated with the usage, handling, and/or the environment of the short wireless communication enabled device 105 and transmit the gathered information to the system via the network communication interface 620 and the microprocessor 610. Examples of IoT sensor 630 used herein may include, but are not limited to, Accelerometers, Air quality sensors, Cameras, Chemical sensors, Electric current sensors, Flow sensors, Gyroscopes, Humidity sensors, Level sensors, Motion sensors, Pressure sensors, Proximity sensors, environment sensors, and/or the like. In an exemplary embodiment of the invention, the IoT sensor 630 may be a Gyro sensor, where the Gyro sensor can detect the direction of rotation, rotation angle, vibration, and/or the like associated with the short wireless communication enabled device 105. Gyro sensors, also known as angular velocity sensors, can detect changes in rotation angle per unit of time. In some embodiments, the short wireless communication enabled device 105 may further comprise a memory (not shown) that comprises computer executable instructions for performing one or more operations described herein. For example, the short wireless communication enabled device 105 may comprise a memory for storing the instructions received from other systems of FIG. 1 (e.g., smart contract, real-time instructions, and/or the like). In some embodiments, the one or more components are controlled by the system of the invention to perform one or more steps of the process flow 500.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for preventing misappropriation of short wireless communication enabled devices, the system comprising:
a memory device with computer-readable program code stored thereon;
a communication device; and
a processing device operatively coupled to the memory device and the communication device, wherein the processing device is configured to execute the computer-readable program code to:
identify initiation of an interaction, via a short wireless communication enabled device, with an interaction device by a user at an entity location;
determine that the short wireless communication enabled device is linked with at least one user device;
determine if the at least one user device is within a predefined distance of the short wireless communication enabled device and the interaction device; and
approve or deny the interaction based on determining that the at least one user device is within the predefined distance of the short wireless communication enabled device.

2. The system according to claim 1, wherein the processing device is further configured to execute the computer-readable program code to:
receive a request from the user to link the at least one user device with the short wireless communication enabled device;
prompt the user to provide a secret code to link the at least one user device with the short wireless communication enabled device; and
verify the secret code and link the at least one user device with the short wireless communication enabled device.

3. The system according to claim 2, wherein the processing device is further configured to execute the computer-readable program code to perform at least one of:
receive one or more interaction limits for the at least one user device, wherein the one or more interaction limits define the interaction capabilities of the at least one user device; and
create a dynamic smart contract associated with the at least one user device and the short wireless communication enabled device based on the one or more interaction limits.

4. The system according to claim 3, wherein the processing device is further configured to execute the computer-readable program code to:
receive updated interaction limits for the at least one user device; and
update the dynamic smart contract with the updated interaction limits.

5. The system of claim 3, wherein the processing device is further configured to execute the computer-readable program code to approve or deny the interaction based on the dynamic smart contract.

6. The system according to claim 1, wherein the processing device is further configured to execute the computer-readable program code to control an Internet of Things (IoT) sensor on the short wireless communication enabled device to record one or more patterns associated with handling of the short wireless communication enabled device.

7. The system according to claim 6, wherein the processing device is further configured to execute the computer-readable program code to:
compare the one or more patterns with baseline data;
determine that the one or more patterns do not match the baseline data; and
generate and transmit an alert to the user based on determining that the one or more patterns do not match the baseline data.

8. A computer program product for preventing misappropriation of short wireless communication enabled devices, the computer program product comprising at least one non-transitory computer readable medium having computer-readable program code portions embodied therein, the computer-readable program code portions comprising executable portions for:
identifying initiation of an interaction, via a short wireless communication enabled device, with an interaction device by a user at an entity location;
determining that the short wireless communication enabled device is linked with at least one user device;
determining if the at least one user device is within a predefined distance of the short wireless communication enabled device and the interaction device; and
approving or denying the interaction based on determining that the at least one user device is within the predefined distance of the short wireless communication enabled device.

9. The computer program product of claim 8, wherein the computer-readable program code portions comprising executable portions for:
receiving a request from the user to link the at least one user device with the short wireless communication enabled device;
prompting the user to provide a secret code to link the at least one user device with the short wireless communication enabled device; and
verifying the secret code and link the at least one user device with the short wireless communication enabled device.

10. The computer program product of claim 9, wherein the computer-readable program code portions comprising executable portions for:
receiving one or more interaction limits for the at least one user device, wherein the one or more interaction limits define the interaction capabilities of the at least one user device; and
creating a dynamic smart contract associated with the at least one user device and the short wireless communication enabled device based on the one or more interaction limits.

11. The computer program product of claim 10, wherein the computer-readable program code portions comprising executable portions for:
receiving updated interaction limits for the at least one user device; and
updating the dynamic smart contract with the updated interaction limits.

12. The computer program product of claim 8, wherein the computer-readable program code portions comprising executable portions for controlling an Internet of Things (IoT) sensor on the short wireless communication enabled device to record one or more patterns associated with handling of the short wireless communication enabled device.

13. The computer program product of claim 12, wherein the computer-readable program code portions comprising executable portions for:
comparing the one or more patterns with baseline data;
determining that the one or more patterns do not match the baseline data; and
generating and transmitting an alert to the user based on determining that the one or more patterns do not match the baseline data.

14. A computer-implemented method for preventing misappropriation of short wireless communication enabled devices, the method comprising:
identifying initiation of an interaction, via a short wireless communication enabled device, with an interaction device by a user at an entity location;
determining that the short wireless communication enabled device is linked with at least one user device;
determining if the at least one user device is within a predefined distance of the short wireless communication enabled device and the interaction device; and
approving or denying the interaction based on determining that the at least one user device is within the predefined distance of the short wireless communication enabled device.

15. The computer-implemented method of claim 14, wherein the method comprises:
receiving a request from the user to link the at least one user device with the short wireless communication enabled device;
prompting the user to provide a secret code to link the at least one user device with the short wireless communication enabled device; and
verifying the secret code and link the at least one user device with the short wireless communication enabled device.

16. The computer-implemented method of claim 15, wherein the method further comprises:
receiving one or more interaction limits for the at least one user device, wherein the one or more interaction limits define the interaction capabilities of the at least one user device; and
creating a dynamic smart contract associated with the at least one user device and the short wireless communication enabled device based on the one or more interaction limits.

17. The computer-implemented method of claim 16, wherein the method comprises:
receiving updated interaction limits for the at least one user device; and
updating the dynamic smart contract with the updated interaction limits.

18. The computer-implemented method of claim 16, wherein the method comprises approving or denying the interaction based on the dynamic smart contract.

19. The computer-implemented method of claim 14, wherein the method comprises controlling an Internet of Things (IoT) sensor on the short wireless communication enabled device to record one or more patterns associated with handling of the short wireless communication enabled device.

20. The computer-implemented method of claim 19, wherein the method comprises:
comparing the one or more patterns with baseline data;
determining that the one or more patterns do not match the baseline data; and
generating and transmitting an alert to the user based on determining that the one or more patterns do not match the baseline data.
